(19) United States
(12) Patent Application Publication
(10) Pub. No.: US 2002/0102370 A1
(43) Pub. Date: Aug. 1, 2002

(54) Apparatus and methods for decorative strip application

(76) Inventors: Michael Glover, Ottawa (CA); Stephen Field, Ottawa (CA)

Correspondence Address: WENDEROTH, LIND & PONACK, L.L.P., 2033 K STREET N. W., SUITE 800, WASHINGTON, DC, 20006-1021, US

(21) Appl. No.: 10/058,105

(22) Filed: Jan. 29, 2002

(30) Foreign Application Priority Data
Jan. 30, 2001 (GB) 0102346.4

(51) Int. Cl. E06B 3/24

(52) U.S. Cl. 428/34

(57) ABSTRACT

In the production of glass sheets particularly for use in heritage windows, a method and apparatus is provided for applying decorative strip material in mutually aligned registration to opposite surfaces of the glazing sheet. The decorative strips may comprise continuous strips of tape or the like as well as strips of paints, inks, ceramic frits, etc. applied by means of brushes, rollers, sprayers and the like. The sheet to which the strips are to be applied is carried on a support structure, and a pair of strip application devices are mounted relative to the support structure in mutually spaced registering positions on a guide structure which accommodates longitudinal relative movement between the strip application devices and the sheet enabling placement of a pair of thin registering strips on opposite surfaces of the sheet.

### BACKGROUND OF THE INVENTION

This invention relates generally to the apparatus for applying decorative strip material to flat sheets, and more particularly to the apparatus and methods of manufacturing decorative features that simulate the appearance of heritage windows.

In U.S. Pat. No. 5,494,715 issued to Glover, it is noted that there is also a growing consumer interest in heritage window features with one popular feature being leaded or stained glass panels. Traditionally, these panels have been made by hand using grooved lead strips or cames. In the past because these handcrafted panels were very labor intensive to produce, various efforts have been made to simplify traditional production techniques and these efforts have been documented in the patent literature.

U.S. Pat. No. 3,226,903 issued to Lillethun describes a triple-glazed sealed unit with a traditional stained-glass panel being incorporated as the center glass lite.

U.S. Pat. Nos. 4,435,170 and 4,438,165 issued to Butler describe a stained glass panel fabricated from a single glass pane where lead profiles are adhered in coincidental alignment to either side of a flat glass sheet. The extruded lead profiles are manually applied and are approximately 0.022 (0.56 mm) inches in thickness. Because of their stiffness and thickness where the lead profiles overlap, the top lead profile has to be stretched and bent around the bottom lead profile and as a result, the process has to be carried out manually with each lead profile being individually applied. To simulate stained glass, lead strips are applied to the glass creating decorative glass patterns incorporating closed segment designs. Colored adhesive film is loosely applied to the opposite side of the glass. The film is then cut to size with the film matching the boundary of the closed segment designs. A second lead strip is then applied to coincide with the first lead strip where the second lead strip overlaps the colored adhesive film.

U.S. Pat. No. 5,494,715 issued to Glover describes a triple pane unit with the center glass pane located only ⅛″ away from the front glass lite. To create the visual illusion of a solid lead came, three thin strips are applied. One strip is applied to the cavity face of the front glass sheet. Traditional lead cames are grey in color, and if all three decorative strips are colored grey, experience has sown that because of the various optical and shadow effects, the visual illusion of a traditional leaded pane window is not always convincingly created. For the triple strip method described in U.S. Pat. No. 5,494,715, one key potential advantage is that the production process can be automated with the objective of producing over a 1000 decorative glass units per eight hour shift. However, the horizontal production equipment described involves glass sheets moving below a multi-head assembly and no automated method or technique is given for applying the strips to the opposite side of the glass.

U.S. Pat. No. 6,180,196 issued to Glover et al describes an alternative production method for manufacturing simulated divided lite windows where the strips are applied in any desired pattern using tape dispensing heads. The production system includes a conveyor for transporting the glass sheet as well as a rotary suction cup which grips the sheet and enables its rotation through e.g. 90° when a second strip is to be applied at right angles to the first. The apparatus also includes a turntable by means of which the glass sheet can be flipped over or inverted when strips are to be applied to both of its sides. Experience has shown that because of problems of accurately cutting and positioning the glass sheet, it is difficult to consistently achieve coincidental alignment of the matching pair of strips.

### SUMMARY OF THE INVENTION

The present invention provides apparatus for applying a pair of parallel decorative thin strips onto respective opposite surfaces of a flat sheet with said pair of decorative thin strips in mutually aligned registration, said apparatus comprising: a support structure for supporting the sheet; a pair of strip application devices mounted relative to said support structure in mutually spaced registering positions to apply the pair of thin strips to opposite surfaces of the sheet; and conveyance structure to accommodate longitudinal relative movement between said pair of strip application devices and the glass sheet to enable placement of the pair of thin strips by the strip application devices over a desired length on the opposite surfaces of the sheet.

As used throughout this specification and in the appended claims, the term “strip” is intended to include not only tapes and other continuous webs and filaments but also other strip- or stripe-like patterns applied to the surface of the flat sheet by any means, including but not limited to by means of brushes, rollers, and sprayers. Thus the strips can be created by the application to the sheet surfaces of tapes, paints, inks, ceramic frits, vapour deposits, etching solutions, and electrostatically charged ink particles.

The support structure may be adapted to support the flat sheet in any desired orientation whether vertical, inclined, or horizontal, the sheet being moved in an advanced direction on the support. There is a gap in the support extending transversely of the sheet and of the advanced direction, two guides being positioned along the gap and on opposite sides of the sheet to support respective strip applying devices in registering position to apply strips simultaneously to opposite sides of the sheet. The strips applied may be of various forms such as adhesive tape; paint; ink; or ceramic frit.

From another aspect the invention provides a method for applying a pair of parallel decorative thin strips onto respective opposite surfaces of a flat sheet with said decorative thin strips in mutually aligned registration, said method comprising: supporting said sheet in a fixed plane; providing a pair of strip application devices in opposed mutually registering positions at a spacing sufficient to accommodate the thickness of said sheet; effecting relative longitudinal movement between said sheet and the pair of strip application devices while simultaneously causing each said device to apply a decorative thin strip onto a respective surface of said sheet with said strips being in mutually aligned registration.

Preferably the sheet is held stationary while the strip application devices apply the decorative thin strips to opposite sides thereof across the full width in a first step. In a second step the sheet is re-positioned to a location where the strip applying devices can apply one or more additional pairs of decorative thin strips in spaced parallel relationship with respect to the first pair. The sheet can then be rotated angularly and positioned such that the strip applying devices can apply a further pair of decorative thin strips at an angle to the first pair or pairs, the sheet being re-positionable to apply additional pairs of decorative thin strips parallel to said further pair.

The invention further provides a sealed glazing unit that simulates the appearance of a heritage window and comprises at least two spaced apart parallel coextensive glazing sheets sealed around their peripheral edges to define at least one glazing panel therebetween, wherein at least one of the glazing sheets has on opposite surfaces thereof a pattern of aligned pairs of decorative thin strips produced by the above described method.

### BRIEF DESCRIPTION OF THE DRAWINGS

The invention will further be described, by way of example only, with reference to the accompanying drawings wherein:

FIG. 1 shows a fragmentary perspective view of a triple glazing unit that simulates the appearance of a leaded came panel;

FIG. 2 shows a fragmentary perspective view of a coincidentally aligned pair of decorative tape strips being applied to a glass sheet;

FIG. 3 shows a cross section detail of two adhesive strips being simultaneously applied to opposite sides of a glass sheet;

FIG. 4 shows a cross section detail of the double head, decorative strip applying apparatus; and

FIG. 5 shows a fragmentary perspective view of the apparatus of FIG. 4.

### DETAILED DESCRIPTION OF THE PREFERRED EMBODIMENTS

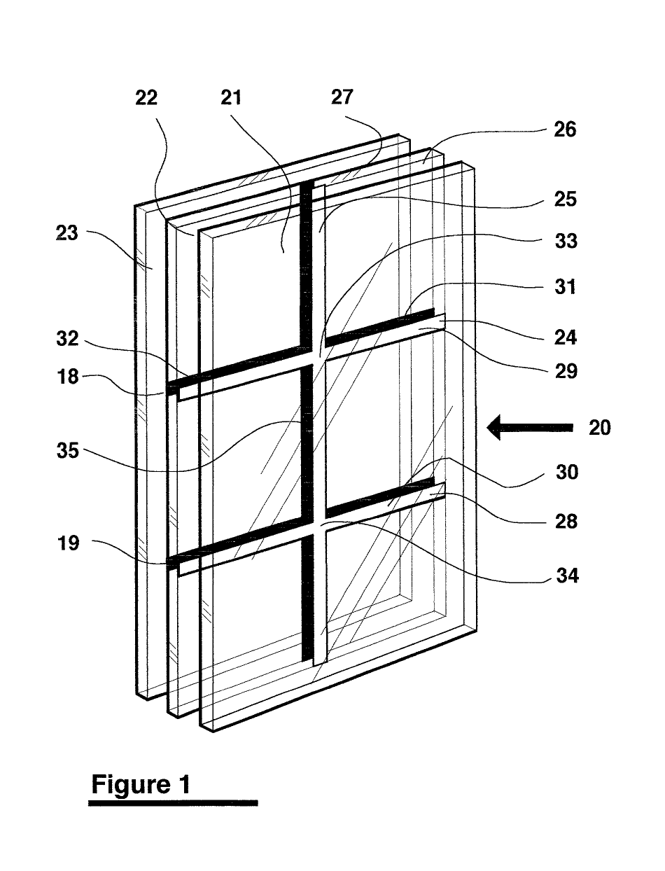

As used throughout the specification the terms “inner” and “outer” in relation to the sides of the glazing unit 20 are intended to refer to the sides of the glazing unit when installed in a building wall that face the interior and exterior of the building respectively. Similarly, the terms “vertical” and “horizontal” as used throughout the specification are in reference to the position of the glazing unit as shown in FIG. 1 of the drawings, and it will be understood that the glazing unit can in fact be positioned in any desired orientation. The glazing unit 20 of FIG. 1 consists of three glazing sheets; an inner glazing sheet 21, an outer glazing sheet 23, and center glazing sheet 22. A vertical strip 25 of adhesive tape material 24 is applied to the inner surface of said center glazing sheet 22.

To create a grid pattern, horizontal strips 28 and 29 are applied at right angles to the vertical strip 25. At the intersections points 33 and 34 between the vertical and horizontal strips, the horizontal strips 28 and 29 are simply laid on top of the vertical strip 25.

The surface 31 of the tape which contacts the glass is adhesive and is of a relatively dark shade whereas the opposite surface 30 of the tape is of a relatively light shade. Through the use of adhesive tapes, a variety of different heritage windows can be simulated. For example, in the case of muntin grid units, the lighter shade is typically white while the darker shade is typically black. For simulated leaded came panels, the lighter shade is typically grey while the darker shade is black. For simulated brass came panels, the light shade is typically a metallized brass finish while the darker shade is black.

For ease of application, and so that there s no need to bend or stretch the tape at the intersection points 33 and 34, the tape material should be less than 0.15 mm in thickness and preferably less than 0.05 mm in thickness.

A second vertical strip 35 is applied to the outer surface 27 of the center glass sheet 22. The second strip 35 is in coincidental alignment with the first strip 25. Similarly, a second set of horizontal strips 18 and 19 are applied to outer surface 27 of the center glass sheet. This second set of horizontal strips is also in coincidental alignment with the first set 28, 29. When the double dual tone strip assembly is viewed at an angle, the visual illusion is created of a traditional heritage window even though compared to traditional windows, the strips have minimal thickness.

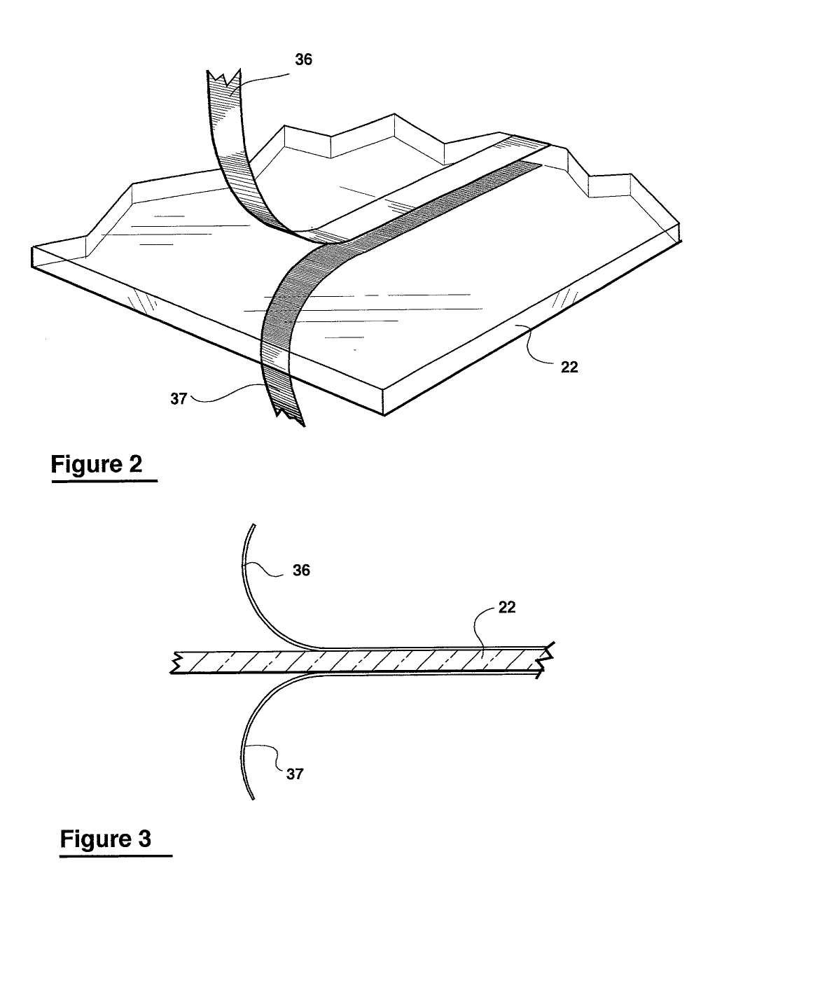

FIG. 2 shows a fragmentary perspective view of a coincidentally aligned pair of decorative tape strips 36, 37 being applied to a glass sheet 22. As both adhesive strips 36, 37 are applied simultaneously to the glass sheet, the need to flip over the glass sheet 22 is eliminated and it is feasible to align the strips very accurately.

FIG. 3 shows a cross section detail of two adhesive tape strips 36 and 37 being simultaneously applied to opposite sides of a glass sheet 22. In addition to adhesive tape, the dual tone strips can be produced from a variety of materials, including: metallic foil, paint or ink, and heat release ceramic decals. Particularly for paint or ink technology and depending on the curing system employed, the paired strips may not be applied exactly simultaneously as shown. However in order to ensure that the paired strips are fully aligned, both strips need to be applied to the respective opposite sides of the glass sheet while the glass sheet is in a fixed and stationary position.

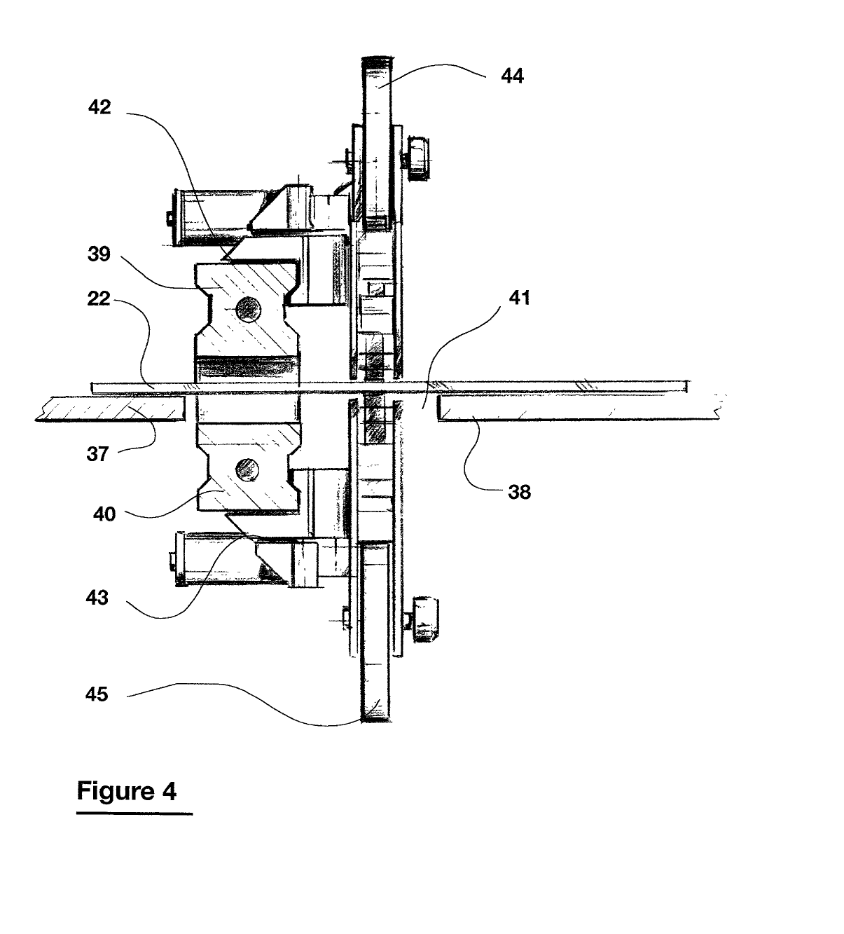

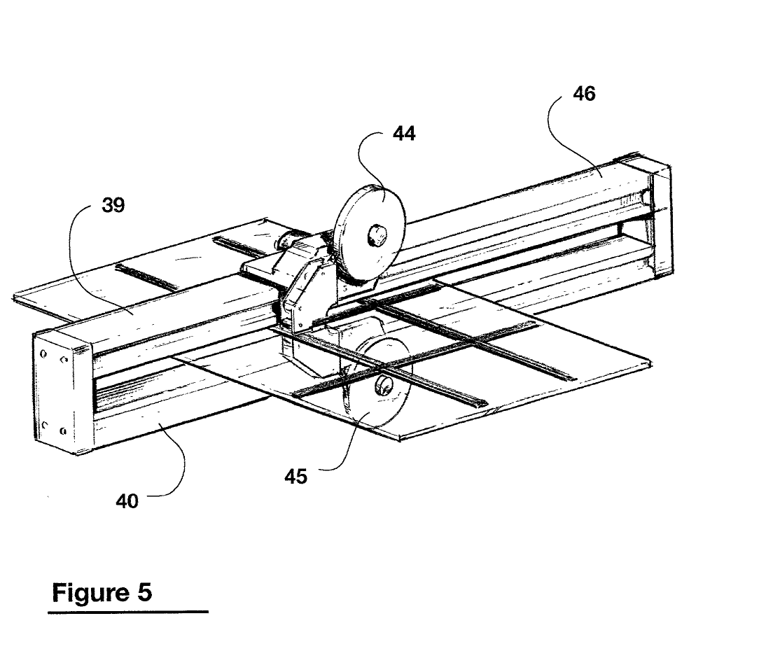

FIG. 4 shows a cross section detail of the apparatus for applying decorative strips in coincident alignment to flat glazing sheets. The strip application equipment 46 consists of two side-by-side flat surface support structures 37 and 38 separated by a gap 41. A glass sheet 22 spans across the gap between the two support structures 37, 38. These support structures can either be horizontally or vertically oriented or inclined, and may incorporate air float mechanisms (not shown) to assist glass movement. Upper and lower support bridges 39, 40 are located over a gap 41 between the two support structures 37, 38. The two bridges 39, 40 span between the two sides of the support structures and linear motion systems 42, 43 are attached to each bridge. Moveable tape application heads 44, 45 are supported by the linear motion systems 42, 43 that are guided on the bridges 39, 40 to move the tape heads lengthwise of the bridges. A key feature is that the two tape application heads 44, 45 can be individually adjusted so that the applied tapes are in fully registered alignment when applied to the glass sheet 22.

FIG. 5 shows a fragmentary perspective view of the strip application equipment 46. For the application process, the glass sheet 22 is first accurately positioned using a special handling system (not shown). After the first pair of strips have been applied, the glass sheet is then advanced and accurately repositioned. A second pair of strips is then applied parallel to the first pair and the process is repeated until a first series of parallel paired strips have been applied. The glass sheet is then rotated through a given angle and a second series of paired strips are applied which intersect and cross the first series of paired strips.

It should be understood that while for clarity certain features of the invention are described in the context of separate embodiments, these features may also be provided in combination in a single embodiment. Furthermore, various features of the invention which for brevity are described in the context of a single embodiment may also be provided separately or in any suitable sub-combination in other embodiments.

Moreover, although particular embodiments of the invention have been described and illustrated herein, it will be recognized that modifications and variations may readily occur to those skilled in the art, and consequently it is intended that the claims appended hereto be interpreted to cover all such modifications and equivalents.

Claims:

1. Apparatus for applying a pair of parallel decorative thin strips onto respective opposite surfaces of a flat sheet with said pair of decorative thin strips in mutually aligned registration, said apparatus comprising:
a support structure for supporting the sheet;
a pair of strip application devices mounted relative to said support structure in mutually spaced registering positions to apply the pair of thin strips to opposite surfaces of the sheet; and
conveyance structure to accommodate longitudinal relative movement between said pair of strip application devices and the glass sheet to enable placement of the pair of thin strips by the strip application devices over a desired length on the opposite surfaces of the sheet.

2. Apparatus as claimed in claim 1 wherein said conveyance structure comprises a pair of rigidly fixed longitudinally extending guides carried on said support structure each guide providing linear guidance for movement of a respective one of said strip application devices during strip application the sheet being held stationary.

3. Apparatus as claimed in claim 2 wherein said support structure provides a horizontal surface for support of the sheet.

4. Apparatus as claimed in claim 2 wherein said support structure provides a vertical surface against which the sheet is engaged during strip application.

5. Apparatus as claimed in claim 2 wherein said support structure includes a support surface against which the sheet is to be engaged during strip application, said support surface having a gap extending transversely thereof and said guides being located along said gap such that said strip applicating devices are guided for movement longitudinally of said gap and have access to opposite surfaces of said sheet.

6. Apparatus as claimed in claim 1 including an adjustment mechanism associated with at least one of said strip applying devices, said adjustment mechanism being operative to effect lateral adjustment in the position of said at least one strip applying device to effect proper registration of the pair of strips that are to be applied.

7. An apparatus as claimed in claim 1 further incorporating sheet conveyance mechanism to effect movement of said glass sheets in a direction perpendicular to the parallel decorative thin strips between applications of pairs of the latter.

8. Apparatus as claimed in claim 1 wherein said strip application devices are configured to apply strips formed from any one of: adhesive tape; paint; ink; or ceramic frit.

9. A method for applying a pair of parallel decorative thin strips onto respective opposite surfaces of a flat sheet with said decorative thin strips in mutually aligned registration, said method comprising:
supporting said sheet in a fixed plane;
providing a pair of strip application devices in opposed mutually registering positions at a spacing sufficient to accommodate the thickness of said sheet;
effecting relative longitudinal movement between said sheet and the pair of strip application devices while simultaneously causing each said device to apply a decorative thin strip onto a respective surface of said sheet with said strips being in mutually aligned registration.

10. A method as claimed in claim 9 comprising holding said sheet stationary while simultaneously moving said strip application devices longitudinally to apply registering decorative thin strips across the full width of the sheet in a first step.

11. The method of claim 9 wherein in a second step the sheet is repositioned to a location wherein said strip applying devices can apply a second pair of decorative thin strips in spaced parallel relationship with respect to said first pair.

12. The method of claim 11 wherein said sheet is angularly rotated and positioned such that the strip applying devices can apply a further pair of decorative thin strips at an angle to said first pair.

13. The method of claim 12 wherein said sheet is repositioned to apply additional pairs of decorative thin strips parallel to said further pair.

14. A sealed glazing unit that simulates the appearance of a heritage window, said glazing unit comprising:
at least two spaced apart parallel co-extensive glazing sheets;
at least one peripheral seal extending continuously between the edges of said glazing sheets to define at least one glazing cavity between said glazing sheets;
wherein at least one of said glazing sheets has on opposed surfaces thereof a pattern of aligned pairs of decorative thin strips formed by a method according to claim 9.
